(19) United States
(12) Patent Application Publication
(10) Pub. No.: US 2024/0354651 A1
(43) Pub. Date: Oct. 24, 2024

(54) SYSTEM AND METHOD FOR ADDING EXPLAINABILITY TO DEEP LEARNING MODELS USING RULE-SET EVOLUTION

(71) Applicant: Cognizant Technology Solutions US Corp, Teaneck, NJ (US)

(72) Inventors: Risto Miikkulainen, Palo Alto, CA (US); Babak Hodjat, Dublin, CA (US); Hormoz Shahrzad, Dublin, CA (US)

(21) Appl. No.: 18/641,886

(22) Filed: Apr. 22, 2024

Related U.S. Application Data
(60) Provisional application No. 63/460,662, filed on Apr. 20, 2023.

(51) Int. Cl. G06N 20/00

(52) U.S. Cl. CPC G06N 20/00

(57) ABSTRACT

A system and method for adding explainability to deep learning models based on rule-set evolution is provided. A set of inputs from an input unit is received which comprises pre-generated deep learning models. Set of inputs is evaluated using pre-defined querying datasets. An output comprising outcomes of the evaluation is generated and mapped with each of the pre-defined querying datasets used for querying deep learning model. A new dataset is generated based on the mapping. Population of initial rule-set models is randomly generated based on a set of hyper parameters. The hyper parameters relate to configuration parameters used for generating population of initial rule-set models. An evolution process is carried out on generated rule-set models for evolving the rule-set models by using the generated new datasets. Lastly, the evolved rule-set model is executed to solve one or more real-world problems.

### CROSS REFERENCE TO RELATED APPLICATION

This application is related to and claims the benefit of U.S. Provisional patent application Ser. No. 63/460,662 filed on Apr. 20, 2023, the entire contents of which are herein incorporated by reference.

### FIELD OF THE INVENTION

The present invention relates generally to the field of artificial intelligence and machine learning, and more particularly, to a system and a method for adding explainability to deep learning models based on rule-set evolution.

### BACKGROUND OF THE INVENTION

Application of Artificial Intelligence and Machine Learning (AI and ML) techniques, such as deep learning models, for carrying out various activities and solving various problems have become prevalent with time. Typically, most of today's popular and powerful deep learning models operate on inherent black-box approaches such as neural networks, and random forests. As such, application of deep learning models is difficult to explain, and their functionality in critical and sensitive use-case scenarios cannot be fully identified. It has been observed that it is difficult to modify deep learning techniques to remove biases or add known constraints. Therefore, in some domains, such lack of transparency can lead to costly failures (e.g., in self-driven cars), and in some other instances mandatory regulations (e.g., insurance) or ethical concerns (e.g., gender or racial biases) cannot be met.

It has been observed that current AI and ML techniques using deep learning models, etc., can be trained with sufficient training data for carrying out various operations such as classifications, point prediction and task generation operations. However, such deep learning models are opaque (i.e., black box), as they generate outputs based on a high number of parallel, elementary calculations that are hard to interpret and understand in aggregate. The output generated by such deep learning models might be accurate and useful, however, it is difficult to determine as to how the respective deep learning model generated the output. Further, deploying of deep learning models is difficult to justify in the real-world scenario. Also, various practices have been developed to determine behavior of deep learning by models interrogating them post training. Through this interrogation-based approach, the output for multiple inputs can be predicted. However, post-training interrogation-based explanations are not complete and accurate for all cases and are still open to interpretations.

In light of the aforementioned drawbacks, there is a need for a system and a method which provides for adding explainability to deep learning models. There is a need for a system and a method which provides for generating insights for explainability of the deep learning models. Further, there is a need for a system and a method which provides for determining internal process of the deep learning models and identify the computation carried out to generate a decision or a prediction with precision.

### SUMMARY OF THE INVENTION

In various embodiments of the present invention, a system for adding explainability to deep learning models based on rule-set evolution is provided. The system comprises a memory storing program instructions, a processor executing instructions stored in the memory, and a rule-set model generation engine executed by the processor and configured to receive a set of inputs from an input unit. The set of inputs comprises one or more pre-generated deep learning models. The system is configured to evaluate the set of inputs by querying the set of inputs with one or more pre-defined querying datasets. Further, the system is configured to generate an output comprising one or more outcomes of the evaluation. Further, the system is configured to map the output with each of the pre-defined querying datasets used for querying the deep learning model. A new dataset is generated based on the mapping. Further, the system is configured to randomly generate a population of initial rule-set models based on a set of hyper parameters, wherein the hyper parameters relate to configuration parameters used for generating population of initial rule-set models. Furthermore, the system is configured to carry out an evolution process on the generated rule-set models for evolving the rule-set models by using the generated new datasets. Lastly, the system is configured execute the evolved rule-set model to solve one or more real-world problems.

In various embodiments of the present invention, a method for adding explainability to deep learning models based on rule-set evolution is provided. The method comprises receiving a set of inputs from an input unit. The set of inputs comprises one or more pre-generated deep learning models. The method comprises evaluating the set of inputs by querying the set of inputs with one or more pre-defined querying datasets. Further, the method comprises generating an output comprising one or more outcomes of the evaluation. Yet further, the method comprises mapping the output with each of the pre-defined querying datasets used for querying the deep learning model. A new dataset is generated based on the mapping. The method further comprises randomly generating population of initial rule-set models based on a set of hyper parameters. The hyper parameters relate to configuration parameters used for generating population of initial rule-set models. Furthermore, the method comprises carrying out an evolution process on the generated rule-set models for evolving the rule-set models by using the generated new datasets. Lastly, the method comprises executing the evolved rule-set model to solve one or more real-world problems.

In various embodiments of the present invention, a computer program product comprising a non-transitory computer-readable medium having computer program code stored thereon, the computer-readable program code comprising instructions that, when executed by a processor, causes the processor to receive a set of inputs from an input unit. The set of inputs relates to one or more pre-generated deep learning models. Further, the set of inputs are evaluated by querying the set of inputs with one or more pre-defined querying datasets. An output comprising one or more outcomes of the querying operation is generated based on the evaluation. The output is mapped with each of the pre-defined querying datasets used for querying the deep learning model. A new dataset is generated based on the mapping. Further, population of initial rule-set models is randomly generated based on a set of hyper parameters. The hyper parameters relate to configuration parameters used for generating population of initial rule-set models. Yet further, an evolution process is carried out on the generated rule-set models for evolving the rule-set models by using the generated new datasets. Lastly, the evolved rule-set model is executed to solve one or more real-world problems.

### BRIEF DESCRIPTION OF THE ACCOMPANYING DRAWINGS

The present invention is described by way of embodiments illustrated in the accompanying drawings wherein:

FIG. 1 is a detailed block diagram of a system for adding explainability to deep learning models using rule-set evolution, in accordance with an embodiment of the present invention;

FIGS. 2 and 2A illustrate a flowchart depicting a method for adding explainability to deep learning models using rule-set evolution, in accordance with an embodiment of the present invention; and

FIG. 3 illustrates an exemplary computer system in which various embodiments of the present invention may be implemented.

### DETAILED DESCRIPTION OF THE INVENTION

The present invention discloses a system and a method which provides for adding explainability to deep learning models based on rule-set evolution. The present invention discloses a system and a method which provides for efficiently interpreting deep learning models generated using the Artificial Intelligence and Machine Learning (AI and ML) techniques. The present invention discloses a system and a method which provides for generating transparent rule-sets, which are twin of the deep learning models, in order to make the deep learning models explainable. Further, the present invention discloses a system and a method which provides for using a set of inputs for determining performance of the deep learning models by pairing each input to the deep learning model with an output that the model generates. The present invention provides a system and a method for evolving the rule-sets to duplicate the performance of the deep learning models in a cost effective manner.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

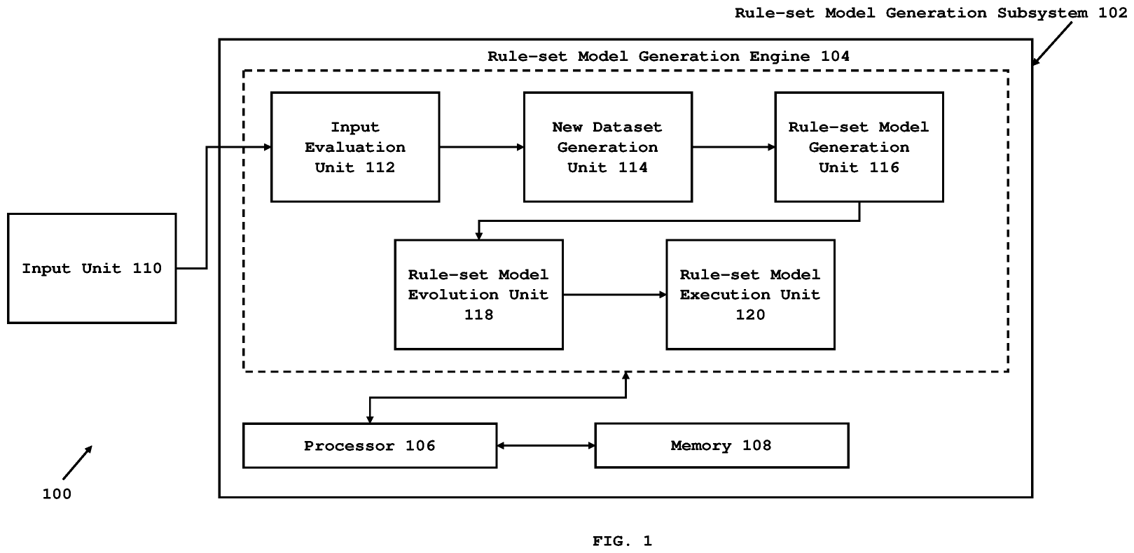

FIG. 1 is a detailed block diagram of a system 100 for adding explainability to deep learning models based on rule-set evolution, in accordance with various embodiments of the present invention. Referring to FIG. 1, in an embodiment of the present invention, the system 100 comprises a rule-set model generation subsystem 102 and an input unit 110. The rule-set model generation subsystem 102 and the input unit 110 are connected to each other via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a Local Area Network (LAN), a Metropolitan Area Network (MAN) and a Wide Area Network (WAN).

In an embodiment of the present invention, the system 100 is configured with a built-in-intelligent mechanism for generating rule-set models which are twin of deep learning models. The generated rule-set models provide explainability with respect to the deep learning models. The system 100 is configured to generate a transparent explainable rule-set models equivalent to the deep learning models that performs like the deep learning models for providing domain insights. Further, the system 100 is configured to evolve the rule-set models for duplicating the performance of the deep learning models.

In an embodiment of the present invention, the subsystem 102 comprises a rule-set model generation engine 104 (engine 104), a processor 106 and a memory 108. In various embodiments of the present invention, the engine 104 is configured to provide explainability to deep learning models based on rule-set evolution. The various units of the engine 104 are operated via the processor 106 specifically programmed to execute instructions stored in the memory 108 for executing respective functionalities of the units of the engine 104 in accordance with various embodiments of the present invention.

In an embodiment of the present invention, the engine 104 comprises an input evaluation unit 112, a new dataset generation unit 114, a rule-set model generation unit 116, a rule-set model evolution unit 118 and a rule-set model execution unit 120.

In operation, in an embodiment of the present invention, the input evaluation unit 112 is configured to receive one or more pre-generated deep learning models as a set of inputs from the input unit 110. The deep learning models, implemented in various domains, are extremely large and trained with a huge number of datasets and computational resources. In an embodiment of the present invention, the input evaluation unit 112 is configured to evaluate the received set of inputs by carrying out a querying operation. The querying operation is carried out by querying the set of inputs with one or more pre-defined querying dataset types including, but not limited to, training datasets, validation datasets, testing datasets which are used for generating the deep learning models, and synthetically generated datasets. In an example, if the deep learning model was trained for recognizing objects in images, then the querying dataset comprises sample images. Further, if the deep learning model was trained to predict outcome of a particular medical treatment for a particular patient, then the querying dataset comprises the patient and treatment description. In an embodiment of the present invention, the input evaluation unit 112 generates an output subsequent to carrying out the querying operation. The generated output comprises one or more outcomes of querying operation relating to the deep learning models when the models are queried with the pre-defined querying datasets.

In an embodiment of the present invention, the new dataset generation unit 114 is configured to receive the output from the input evaluation unit 112. The new dataset generation unit 114 is configured to carry out a mapping operation for mapping the output with each of the pre-defined querying datasets used for querying the deep learning model. The new dataset generation unit 114 is configured to generate new datasets by carrying out the mapping operation. The new dataset represents functioning of the deep learning model.

In an embodiment of the present invention, the rule-set model generation unit 116, upon being triggered by the new dataset generation unit 114, is configured to randomly generate population of initial rule-set models based on a set of hyper parameters. The hyper parameters relate to configuration parameters used for generating initial rule-set models. The configuration parameters include, but are not limited to, features, constants and actions which are chosen randomly. Further, each initial rule-set model may comprise a single rule which is associated with a single condition. In an example, a population of 100 initial rule-set models may be generated. The number of rule-set models and their antecedents and consequents are chosen randomly. In another embodiment of the present invention, 100 examples may be randomly selected from a dataset for generating the initial rule-set models such that each example relates to a particular rule-set model. In another embodiment of the present invention, the rule-set models may be generated manually for providing a baseline performance. The generated initial rule-set models are transparent, explainable, and equivalent twin of the deep learning model. In an embodiment of the present invention, the generated rule-set models are based on predicate logic expression. The rule-set models are collections of statements of the form “IF a condition A is met THEN consequence B occurs”. In an exemplary embodiment, the generated rule-set model is represented as below:

< rules > ::= < rule > | < rule > OR < rules >
< rule > ::= < conditions > → [< certainty >] < action >
< conditions > ::= < condition > | < condition > AND <
conditions >
< condition > ::= < leading >< operator >< trailing >
< leading > ::= < coefficient > * < feature >[<power>] [
(lag)]
< trailing > ::= < leading > | < value >
< operator > :: = ” < ” | ” ≤ ” | ” > ” | ” ≥ ”
< coefficient > ::= 0. [0 - 9]+
< value > ::= (a number between min and max feature value)
< power > ::= [1 - 3] (keep it to more meaningful values.)
< lag > : : = [0 - 9] (or the desired lag range to be explored.)
< feature > ::= (an arbitrary input feature)
< action > ::= (a predicted class or prescribed action)
< certainty > ::= < coefficient > (confidence of a prediction
or action)

The aforementioned rule-set model representation shows comparison between a single feature with a constant value, comparison between features, power expressions, and prediction/action probabilities. In the case of parsing an individual's rule-set, conditions are evaluated in order and all actions for conditions that are met are returned. The application of subset of the actions is based on a specific domain. In some domains, only the first action is executed. In other domains, a hard-max filter is used to select one of the actions based on action coefficients or all actions may be executed in parallel or in sequence and the actions are domain specific.

In an embodiment of the present invention, the rule-set model evolution unit 118 is configured to receive the generated initial rule-set models from the rule-set model generation unit 116 for carrying out an evolution process by using the generated new datasets. The rule-set model evolution unit 118 is configured to carry out the evolution process for evolving the initial rule-set models population by firstly reproducing the rule-set models based on selection of parents from the generated rule-set models. The selection of parents is carried out by applying a genetic evolution technique such as, but is not limited to, a tournament selection technique, a fitness-proportionate technique, a roulette-wheel technique, a rank technique, an elitist technique, and a steady state technique. In an embodiment of the present invention, the rule-set model evolution unit 118 is further configured to generate offsprings by applying a crossover technique and a mutation technique on the selected parents. In an embodiment of the present invention, a first crossover technique is applied by the rule-set model evolution unit 118 by selecting a random crossover index less than the number of rule-set models in one parent individual and in the offspring rule-set model, and replacing remainder rule-set models in that individual with rules past the crossover index from the other parent. Therefore, with respect to the produced offspring, the number of rules can potentially grow or shrink relative to their parents. In another embodiment of the present invention, a second crossover technique is applied by the rule-set model evolution unit 118 by carrying out a logical multiplication of one parent rule-set models into the second parent for producing offspring with longer rules than the parents. As such, either the first crossover technique or the second crossover technique may be selected randomly.

In an embodiment of the present invention, the mutation technique is applied by the rule-set model evolution unit 118 by carrying out a single random change in an element of the rule-set model. The mutation technique may apply at the condition level by changing an element of the condition, or at the rule level by replacing, removing, or adding a condition to the rule-set model, or changing the rule-set model's action. The mutation technique may also be applied at the rule-set model level by removing an entire rule-set from the parent, or changing the default rule-set, or changing the rule-set order. The mutation technique therefore makes the offspring smaller or larger than the original parent, which is referred to as a bloat. In order to reduce the bloat, all conditions recognized as falsehoods are removed from the offsprings. Further, a counter technique referred to as a times-applied counter technique is associated with each rule-set for keeping track as to how many number of times the rule-set was evaluated as ‘true’ during evaluation. Another bloat-control technique utilizes the times-applied counter technique to filter inactive individual rule-sets from participating in crossover. The times-applied counter can also be useful to determine each rule-set's coverage and generality with a very low count which may be an indication of over-fitting or even a corner case bias. In an embodiment of the present invention, an expression vocabulary associated with the evolved rule-set models is expanded during evolution. For example, the process could be started with a pre-determined set of operators which could then be expanded as evolution progresses, by implementing a curricular learning. In an embodiment of the present invention, the evolved rule-set models replicate the performance of a deep learning model.

In an embodiment of the present invention, the rule-set model execution unit 120 is configured to receive the evolved rule-set model from the rule-set model evolution unit 118 for executing the rule-set model to solve one or more real-world problems. The real-world problems comprise, but are not limited to, prediction or classification problems and prescription or action determination problems. In prediction or classification problems, the rule-set model duplicates the behavior of the deep learning models trained with a supervised dataset. In prescription or action determination problems, the rule-set models duplicate the performance of the deep learning models evolved to optimize the outcomes of prescriptions. Similar prescriptions occur when evaluation is done directly and through a surrogate model. Advantageously, evolved rule-set models are meaningful to domain experts and in some cases provide useful insight, thereby increasing explainability of the black-box deep learning models.

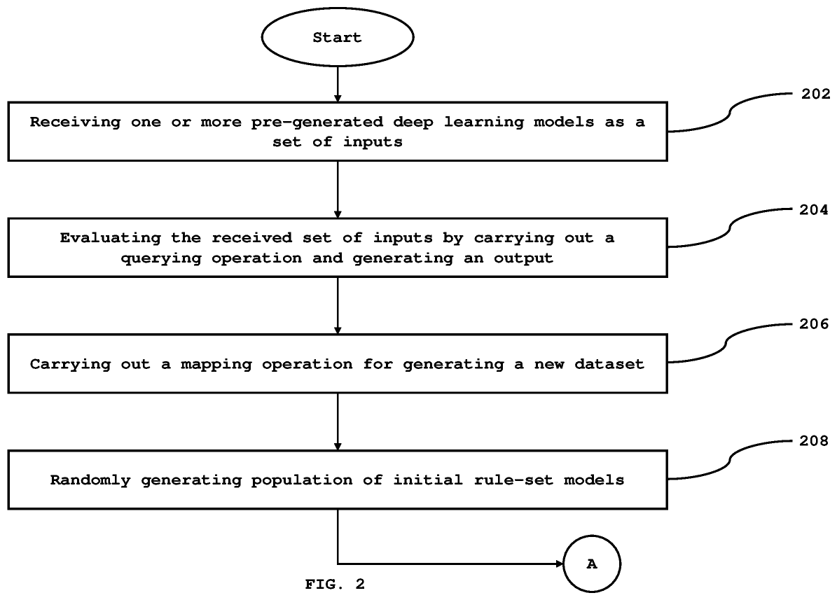

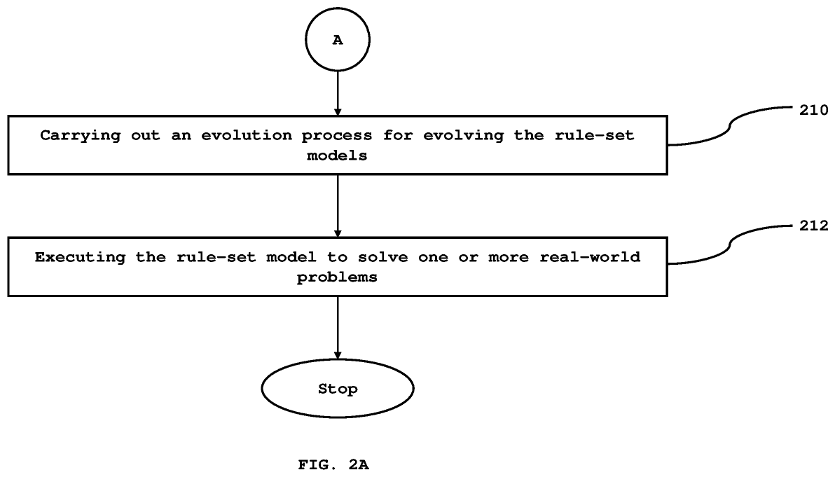

FIGS. 2 and 2A illustrate a flowchart depicting a method for adding explainability to deep learning models by using rule-set evolution, in accordance with various embodiments of the present invention.

At step 202, one or more pre-generated deep learning models are received as a set of input. In an embodiment of the present invention, the deep learning models, implemented in various domains, are extremely large and trained with a huge number of datasets and computational resources. At step 204, the received set of inputs are evaluated by carrying out a querying operation and generating an output. In an embodiment of the present invention, the querying operation is carried out for querying the set of inputs with one or more pre-defined querying dataset types. The pre-defined querying dataset types include, but are not limited to, training datasets, validation datasets, testing datasets which are used for generating the deep learning model, and synthetically generated datasets. In an example, if the deep learning model was trained for recognizing objects in images, then the querying dataset comprises sample images. Further, if the deep learning model was trained to predict outcome of a particular medical treatment for a particular patient, then the querying dataset comprises the patient and treatment description. In an embodiment of the present invention, the output is generated subsequent to carrying out of the querying operation. The generated output comprises one or more outcomes of querying operation relating to the deep learning model when the deep learning model is queried with the pre-defined querying datasets.

At step 206, a mapping operation is carried out for generating a new dataset. In an embodiment of the present invention, a mapping operation is carried out for mapping the output with each of the pre-defined querying datasets used for querying the deep learning model. A new dataset is generated by carrying out the mapping operation. The new dataset represents functioning of the deep learning model.

At step 208, population of initial rule-set models is randomly In an embodiment of the present invention, population of initial rule-set models based on a set of hyper parameters. The hyper parameters relate to configuration parameters used for generating initial rule-set models. The configuration parameters include, but are not limited to, features, constants and actions which are chosen randomly. Further, each initial rule-set model may comprise a single rule which is associated with a single condition. In an example, a population of 100 initial rule-set models may be generated. Further, the number of rule-set models and their antecedents and consequents are chosen randomly. In another embodiment of the present invention, 100 examples may be randomly selected from a dataset for generating the initial rule-set models such that each example relates to a particular rule-set model. In another embodiment of the present invention, the rule-set models may be generated manually for providing a baseline performance. The generated rule-set models and are explainable an transparent, equivalent twin of the deep learning model. In an embodiment of the present invention, the generated rule-set models are based on predicate logic expression. In an exemplary embodiment of the present invention, the rule-set models are collections of statements of the form “IF a condition A is met THEN consequence B occurs”.

At step 210, an evolution process is carried out for evolving the rule-set models. In an embodiment of the present invention, the evolution process is carried out by using the generated new datasets. The evolution process is carried out for evolving the initial rule-set models population by firstly reproducing the rule-set models based on selection of parents from the generated rule-set models. The selection of parent is carried out by applying a genetic evolution technique such as, but is not limited to, a tournament selection technique, a fitness-proportionate technique, a roulette-wheel technique, a rank technique, an elitist technique, and a steady state technique. In an embodiment of the present invention, offsprings are generated by apply a crossover technique and a mutation technique on the selected parents. In an embodiment of the present invention, a first crossover technique is applied by selecting a random crossover index less than the number of rule-set models in one parent individual and in the offspring rule-set model, and replacing remainder rule-set models in that individual with rules past the crossover index from the other parent. Therefore, with respect to the produced offspring, the number of rules can potentially grow or shrink relative to their parents. In another embodiment of the present invention, a second crossover technique is applied by carrying out a logical multiplication of one parent rule-set models into the second parent for producing offspring with longer rules than the parents. As such, either the first crossover technique or the second crossover technique may be selected randomly.

In an embodiment of the present invention, the mutation technique is applied by carrying out a single random change in an element of the rule-set model. The mutation technique may apply at the condition level by changing an element of the condition, or at the rule level by replacing, removing, or adding a condition to the rule-set model, or changing the rule-set model's action. The mutation technique may also be applied at the rule-set model level by removing an entire rule-set from the parent, or changing the default rule-set, or changing the rule-set order. The mutation technique may thus make the offspring smaller or larger than the original parent, which is referred to as a bloat. In order to reduce the bloat, all conditions recognized as falsehoods are removed from the offsprings. Further, a counter technique referred to as a times-applied counter technique is associated with each rule-set for keeping track as to how many number of times the rule-set was evaluated as true during evaluation. Another bloat-control technique utilizes the times-applied counter technique to filter inactive individual rule-sets from participating in crossover. The times-applied counter can also be useful to get a sense of each rule-set's coverage and generality with a very low count may be an indication of over-fitting or even a corner case bias. In an embodiment of the present invention, an expression vocabulary associated with the evolved rule-set models is expanded during evolution. For example, the process could be started with a pre-determined set of operators which could then be expanded as evolution progresses, by implementing a curricular learning. In an embodiment of the present invention, the evolved rule-set models replicate the performance of a deep learning model.

At step 212, the rule-set model is executed to solve one or more real-world problems. In an embodiment of the present invention, the real-world problems comprise prediction or classification problems and prescription or action determination problems. In prediction or classification problems, the rule-set model duplicates the behavior of the deep learning models trained with a supervised dataset. In prescription or action determination problems, the rule-set models duplicate the performance of the deep learning models evolved to optimize the outcomes of prescriptions. Similar prescriptions occur when evaluation is done directly and through a surrogate model.

Advantageously, in accordance with various embodiments of the present invention, the present invention provides for a system and method for adding explainability to deep learning models by using rule-set distillation. The present invention provides for generating rule-set models which are executable, and which replicate the performance of the black-box model accurately. The present invention provides for deploying the rule-set models instead of the black box models in explanation-critical applications. Further, the present invention provides for using rule-set models to explain the learned behavior. The resulting rule-set models make relationships between concepts explicit, and they can uncover insights into the domain, as well as biases. Further, the generated rule-set models have a linear structure, which aids to avoid the problems of tree evolution like bloat, mutation/crossover, and the generated rule-sets are logically complete. Further, the generated rule-set models are configured to determine non-linear relationships and interactions among the domain features-even as complex as those between time lags in time series data. Yet further, the generated rule-sets can be easily augmented to represent probability in their structure, as well as a variety of operations and functions in their conditions. Furthermore, the present invention provides for using the rule-set models in a real-world domain range of prediction, classification, prescription, and policy search domains, with and without surrogates, and with only a small cost on performance.

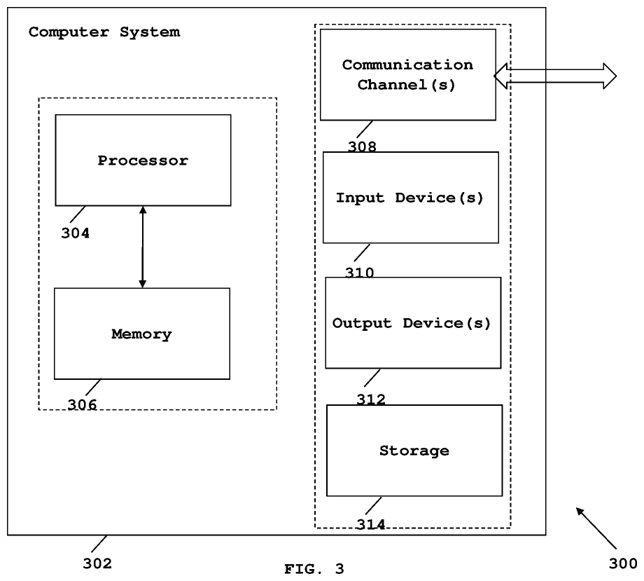

FIG. 3 illustrates an exemplary computer system 300 in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various software executing in the computer system 302 and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for adding explainability to deep learning models based on rule-set evolution, the system comprising:
a memory storing program instructions;
a processor executing instructions stored in the memory; and
a rule-set model generation engine executed by the processor and configured to:
receive a set of inputs from an input unit, wherein the set of inputs comprises one or more pre-generated deep learning models;
evaluate the set of inputs by querying the set of inputs with one or more pre-defined querying datasets;
generate an output comprising one or more outcomes of the evaluation;
map the output with each of the pre-defined querying datasets used for querying the deep learning model, wherein a new dataset is generated based on the mapping;
randomly generate a population of initial rule-set models based on a set of hyper parameters, wherein the hyper parameters relate to configuration parameters used for generating population of initial rule-set models;
carry out an evolution process on the generated rule-set models for evolving the rule-set models by using the generated new datasets; and
execute the evolved rule-set model to solve one or more real-world problems.

2. The system as claimed in claim 1, wherein the one or more pre-defined querying dataset types comprises training datasets, validation datasets, testing datasets which are used for generating the deep learning model and synthetically generated datasets.

3. The system as claimed in claim 1, wherein the rule-set generation engine comprises a rule-set model evolution unit executed by the processor and configured to carry out the evolution process by reproducing the rule-set models based on selection of parents from the generated rule-set models, and wherein the selection of parents is carried out by applying a genetic evolution technique.

4. The system as claimed in claim 3, wherein the rule-set model evolution unit is configured to generate offsprings by applying a crossover technique and a mutation technique on the selected parents.

5. The system as claimed in claim 4, wherein a first crossover technique is applied by selecting a random crossover index less than the number of rule-set models in one parent individual and in the offspring rule-set model, and replacing remainder rule-set models in that individual with rules past the crossover index from the other parent, and wherein a second crossover technique is applied by carrying out a logical multiplication of one parent rule-set model into a second parent for producing offspring with longer rules than the parents.

6. The system as claimed in claim 4, wherein the mutation technique is applied by a rule-set model evolution unit by carrying out a single random change in an element of the rule-set model, and wherein the mutation technique is applied at the condition level by changing an element of the condition, or at the rule level by replacing, removing, or adding a condition to the rule-set model, or changing the rule-set model's action.

7. The system as claimed in claim 6, wherein the mutation technique is applied at the rule-set model level by removing an entire rule-set from the parent, or changing the default rule-set, or changing the rule-set order.

8. The system as claimed in claim 4, wherein the mutation technique generates a bloat by making the offspring smaller or larger than the original parent and wherein in order to reduce the bloat all conditions recognized as falsehoods are removed from the offsprings, and wherein a times-applied counter technique is associated with each rule-set for keeping track of a number of times the rule-set was evaluated as ‘true’ during evaluation, and wherein another bloat-control technique utilizes the times-applied counter technique to filter inactive individual rule-sets from participating in crossover.

9. The system as claimed in claim 1, wherein an expression vocabulary associated with the evolved rule-set models is expanded during evolution by implementing a curricular learning.

10. The system as claimed in claim 1, wherein the evolved rule-set model is applied to solve the real-world problem comprising prediction or classification problems and prescription or action determination problems, and wherein the rule-set model duplicates the behavior of the deep learning models trained with a supervised dataset in the prediction or classification problems, and wherein the rule-set models duplicate the performance of the deep learning models evolved to optimize the outcomes of prescriptions in the prescription or action determination problems, and wherein similar prescriptions occur when evaluation is done directly and through a surrogate model.

11. A method for adding explainability to deep learning models by using rule-set evolution, the method is implemented by a processor executing program instructions stored in a memory, the method comprises:
receiving a set of inputs from an input unit, wherein the set of input comprises one or more pre-generated deep learning models;
evaluating the set of inputs by querying the set of inputs with one or more pre-defined querying datasets;
generating an output comprising one or more outcomes of the evaluation;
mapping the output with each of the pre-defined querying datasets used for querying the deep learning model, wherein a new dataset is generated based on the mapping;
randomly generating population of initial rule-set models based on a set of hyper parameters, wherein the hyper parameters relate to configuration parameters used for generating population of initial rule-set models;
carrying out an evolution process on the generated rule-set models for evolving the rule-set models by using the generated new datasets; and
executing the evolved rule-set model to solve one or more real-world problems.

12. The method as claimed in claim 11, wherein the evolution process is carried out by reproducing the rule-set models based on selection of parents from the generated rule-set models, and wherein the selection of parents is carried out by applying a genetic evolution technique.

13. The method as claimed in claim 12, wherein offsprings are generated by applying a crossover technique and a mutation technique on the selected parents.

14. The method as claimed in claim 13, wherein a first crossover technique is applied by selecting a random crossover index less than the number of rule-set models in one parent individual and in the offspring rule-set model, and replacing remainder rule-set models in that individual with rules past the crossover index from the other parent, and wherein a second crossover technique is applied based on carrying out a logical multiplication of one parent rule-set models into the second parent for producing offspring with longer rules than the parents.

15. The method as claimed in claim 13, wherein the mutation technique is applied by carrying out a single random change in an element of the rule-set model, and wherein the mutation technique is applied at the condition level by changing an element of the condition, or at the rule level by replacing, removing, or adding a condition to the rule-set model, or changing the rule-set model's action.

16. The method as claimed in claim 15, wherein the mutation technique is applied at the rule-set model level by removing an entire rule-set from the parent, or changing the default rule-set, or changing the rule-set order.

17. The method as claimed in claim 16, wherein the mutation technique generates a bloat by making the offspring smaller or larger than the original parent, and wherein in order to reduce the bloat all conditions recognized as falsehoods are removed from the offsprings, and wherein a times-applied counter technique is associated with each rule-set for keeping track on a number of times the rule-set was evaluated as ‘true’ during evaluation, and wherein another bloat-control technique utilizes the times-applied counter technique to filter inactive individual rule-sets from participating in crossover.

18. The method as claimed in claim 11, wherein an expression vocabulary associated with the evolved rule-set models is expanded during evolution by implementing a curricular learning.

19. The method as claimed in claim 11, wherein the evolved rule-set model is applied to solve the real-world problem comprising prediction or classification problems and prescription or action determination problems, and wherein the rule-set model duplicates the behavior of the deep learning models trained with a supervised dataset in the prediction or classification problems, and wherein the rule-set models duplicate the performance of the deep learning models evolved to optimize the outcomes of prescriptions in the prescription or action determination problems, and wherein similar prescriptions occur when evaluation is done directly and through a surrogate model.

20. A computer program product comprising:
a non-transitory computer-readable medium having computer program code stored thereon, the computer-readable program code comprising instructions that, when executed by a processor, causes the processor to:
receive a set of inputs from an input unit, wherein the set of inputs relates to one or more pre-generated deep learning models;
carry out a querying operation for evaluating the set of inputs by querying the set of inputs with one or more pre-defined querying datasets;
generate an output comprising one or more outcomes of the evaluation;
map the output with each of the pre-defined querying datasets used for querying the deep learning model, wherein a new dataset is generated based on the mapping;
randomly generate population of initial rule-set models based on a set of hyper parameters, wherein the hyper parameters relate to configuration parameters used for generating population of initial rule-set models;
carry out an evolution process on the generated rule-set models for evolving the rule-set models by using the generated new datasets; and
execute the evolved rule-set model to solve one or more real-world problems.
